(19) United States
(12) Patent Application Publication
(10) Pub. No.: US 2010/0268660 A1
(43) Pub. Date: Oct. 21, 2010

(54) SYSTEMS AND METHODS FOR VERIFYING AND RATING MORTGAGE FINANCIAL COMPANIES

(76) Inventor: Jared Ekdahl, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 12/761,343

(22) Filed: Apr. 15, 2010

Related U.S. Application Data
(60) Provisional application No. 61/169,641, filed on Apr. 15, 2009.

(51) Int. Cl. G06Q 99/00; G06Q 40/00

(52) U.S. Cl. 705/347

(57) ABSTRACT

System and method for providing mortgage financial company ratings and verifications. A networked-based service provides a user with a lender report summarizing the mortgage loan data of the lender. Key lender loan data is gathered, analyzed, and formatted in an easy to read rating and report of an analyzed lender, thus verifying lender reliability.

### PRIORITY CLAIM

The present application claims priority from U.S. Provisional Application Ser. No. 61/169,641 entitled SYSTEMS AND METHODS FOR VERIFYING AND SCORING MORTGAGE LENDERS AND BANKS filed Apr. 15, 2009, the contents of which are incorporated herein by reference.

### BACKGROUND OF THE INVENTION

Currently brokers need to do a lot of research in order to find a mortgage lender that would be effective at providing a loan for a project the broker is trying to close. Some of the information the brokers need to make a decision is unavailable or only available in a paid service provided by an information vender. Thus, there is a high likelihood that a broker spends a lot of time and money interviewing lenders to determine if they have proper credentials and ability to provide a desired mortgage.

### SUMMARY OF THE INVENTION

The present invention verifies and rates mortgage financial companies to assist customers in choosing a mortgage financial company. A networked-based server allows a user of the present invention to request a lender report of a mortgage financial company. The lender report provides an analysis of historic mortgage loan data, including a lender score based on loan data information. The lender report also allows the user to view an easy to read rating and report of the analyzed lender, thus verifying lender reliability.

### BRIEF DESCRIPTION OF THE DRAWINGS

Preferred and alternative embodiments of the present invention are described in detail below with reference to the following drawings:

FIG. 1 is a block diagram of a system for verifying and rating mortgage financial companies in accordance with an exemplary embodiment of the present invention;

FIGS. 2 and 3 show a flowchart of a method of lender rating in accordance with an exemplary embodiment of the present invention;

FIG. 4A is an example of a lender score card in accordance with an exemplary embodiment of the present invention;

FIG. 4B is an alternative example of a lender score card of FIG. 4A;

FIG. 5A-B show an example of a detailed lender report in accordance with an exemplary embodiment of the present invention;

FIG. 6 is a snap shot of a lender database in accordance with an exemplary embodiment of the present invention; and

FIG. 7 is an example of a lender verification form in accordance with an exemplary embodiment of the present invention.

### DETAILED DESCRIPTION OF THE PREFERRED EMBODIMENT

The present invention provides a system and method for gathering and analyzing key lender loan data and outputting an easy to read rating and report of an analyzed lender, thus verifying lender reliability.

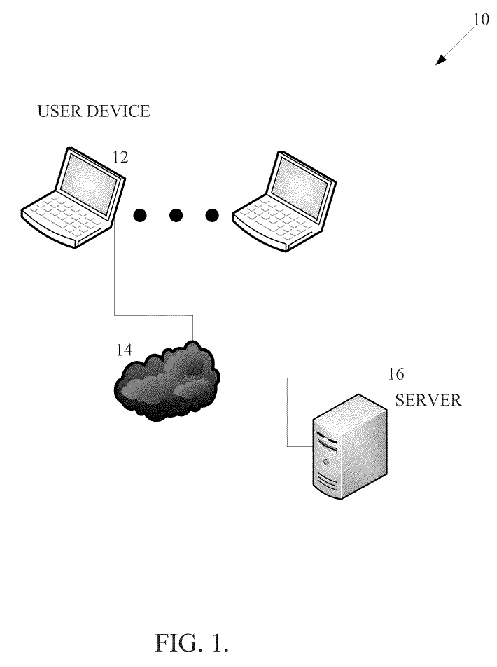

The present invention provides a networked-based service that allows a user to view a score that relates to an analysis of historic mortgage loan data. As shown in FIG. 1, a system 10 includes a public or private data network 14 and a database 18, a server 16 and a plurality of user devices 12 in communication with the network 14. The database 18 may also be in direct communication with the server 16. The user accesses a graphical user interface (GUI) (e.g., webpage) generated by the server 16 on the user device 12 via the network 14. The user devices 12 include but are not limited to desktop computers, laptops, smart phones, or similar devices. The GUI provides lender rating information based on a query initiated by the user and lender information stored in the database 18.

In one embodiment, the server 16 requires a membership in order to be accessed by users. The user can request a lender or select a lender from a list of lenders to get a performance score and/or report with a performance score and other related information.

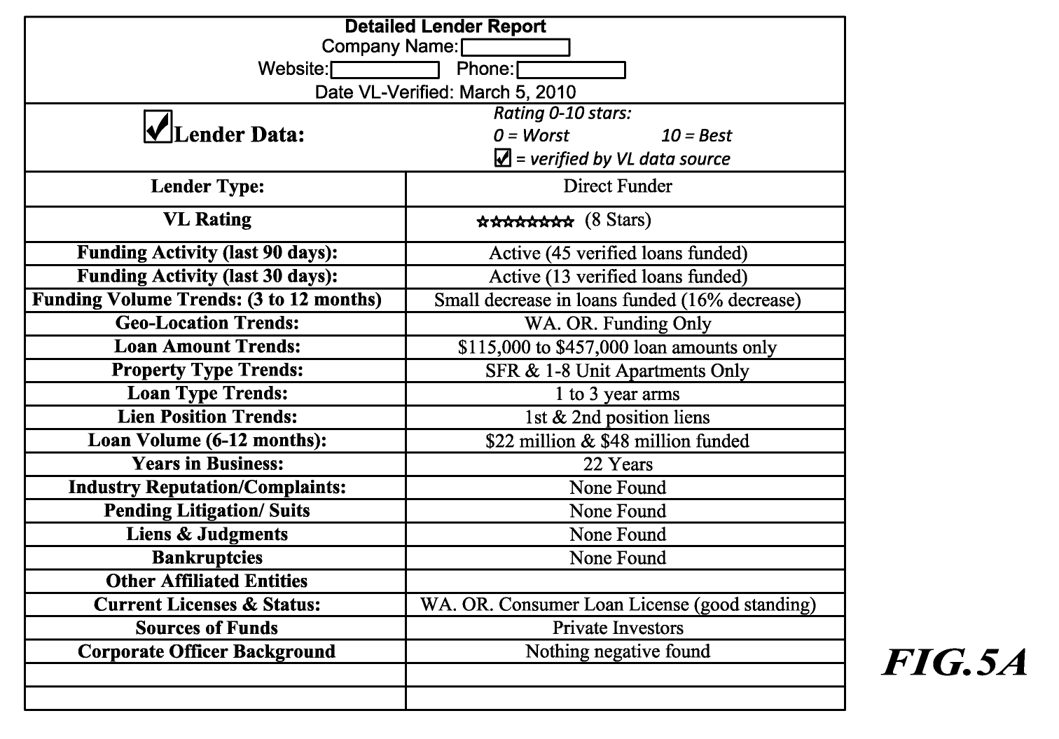

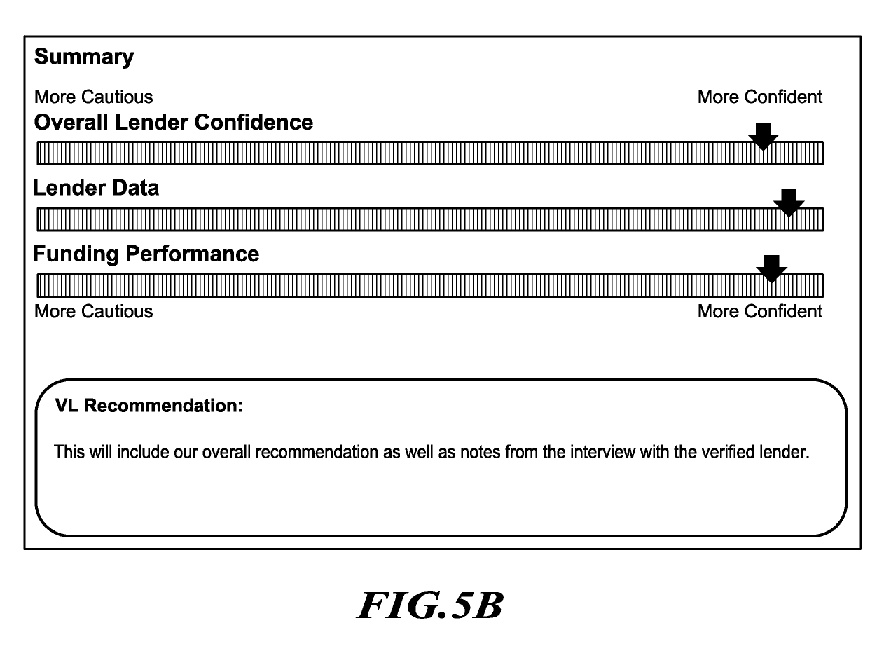

The server 16 gathers mortgage approval information about lenders/banks from the database 18, such as loan funding information (e.g., number of loans funded in the past one to twelve months, size, location, type) and lender information (e.g., assets, revenue, liens, judgments, complaints, lawsuits, officer background, or other business related data), then analyzes that information and produces a score. This score is outputted to the user in an “at a glance”, easy to understand GUI report. Other information relating to the mortgage information is provided in a report format, such as that shown in FIGS. 5A and 5B.

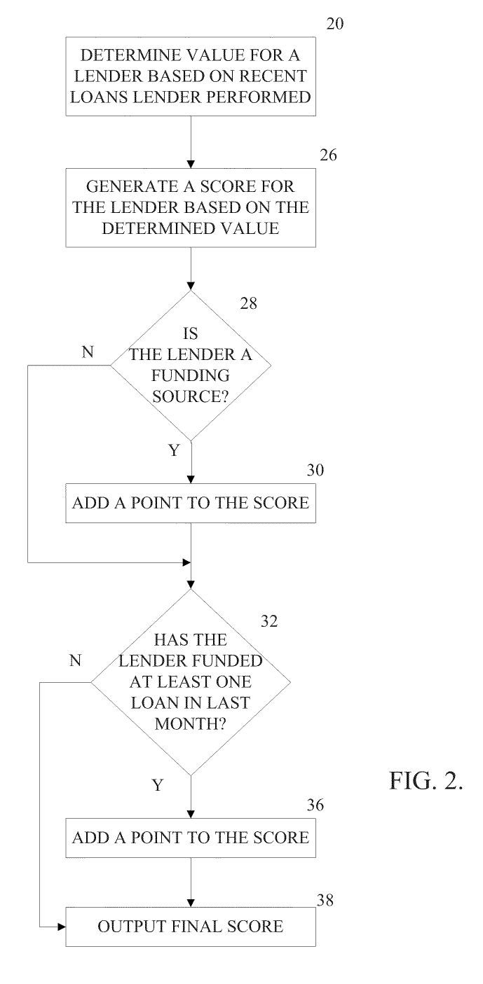

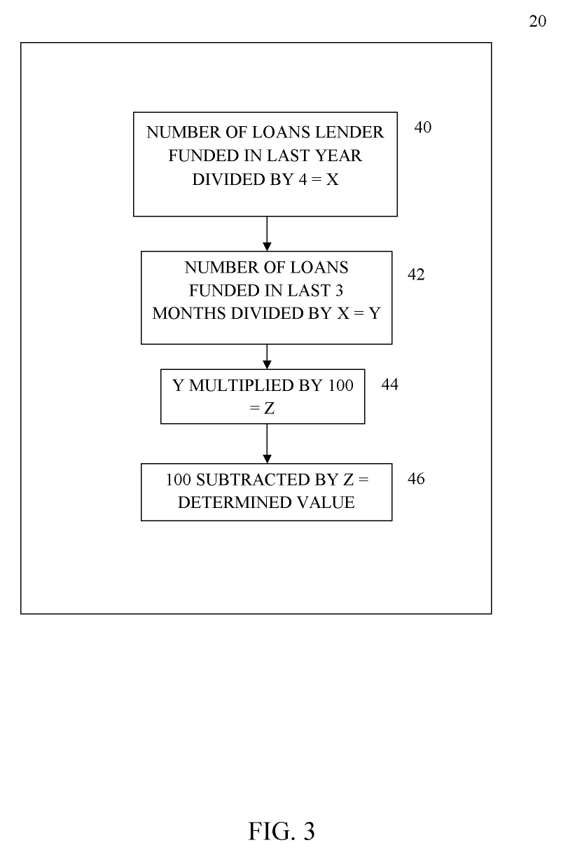

FIG. 2 illustrates an exemplary process performed by the system 10. First, at a block 20, the server 16 determines a value for a user selected lender based on past loans and other things the lender funded stored in the database 18. Value determination is described in more detail in the example shown in FIG. 3. Next, at block 26, a point value is generated for the lender based on the determined value. The point value (percentage increase or decrease) generation performed at block 26 uses the result from block 20 to generate points (used interchangeably with score) from (0-10) based on the following table:

| −200 and below = | 9 to 10 pts |
|---|---|
| −100 to −200 = | 8 pts |
| −0 to −99 = | 7 pts |
| 1 to 25 = | 6 pts |
| 26 to 50 = | 5 pts |
| 51 to 75 = | 4 pts |
| 76 to 99 = | 3 pts |
| 100 = | 0 pts |

Other points, point totals and percentages may be used.

Other information included in the database 18, such as years in business and if there are no complaints suits liens etc. may also be used to generate a point for the score.

At a decision block 28, the server 16 verifies based on information in the database 18 if the lender is a funding source lender. Example funding source lenders include, but are not limited to, conduit, correspondent, brokers, insurance companies, pension funds, agencies, capital and credit companies, REITs, investment and regular banks, opportunity funds, hedge funds, endowment funds, foundations, advisors, trusts, high-net-worth individuals, domestic (regional to money-center) banks, foreign banks, and domestic and foreign syndicators.

This may be simply determining from the gathered mortgage information and other company data (deeds, corporate documents, entities) whether the lender ever closed a loan. Other metrics for making this determination may be used. If the lender has been determined to be a funding source lender, then a point is added to the score, block 30.

At a decision block 32, the server 16 determines if the lender has actively funded at least one loan in at least one previously defined period based on information in the database 18. This determination is also based on analyzing the gathered mortgage information.

For example, any or all of the following may occur. A point is added if at least one loan has been funded by the lender in the past 90 days. A point is added if at least one loan has been funded by the lender in the last month. A point is added if at least one loan has been funded by the lender in the past two months. A point is added if at least one loan has been funded by the lender in the past six months. A point is added if at least one loan has been funded by the lender in the past twelve months.

After the above processes are complete the final score and/or information based on the final score is outputted to the user on a report, see block 38. An example outputted GUIs are shown in FIGS. 5A and 5B.

FIG. 3 shows an example method of determining the value in block 20. First in block 40, the number of loans the lender performed in the last year is divided by 4 (X). This result (X) is divided into the number of loans the lender performed in the last 3 months to get (Y), block 42. This result (Y) is multiplied by 100 to get (Z), block 44, then (Z) is subtracted from 100 to produce the determined value, block 46. Other periods of time used to analyze the data can be selected.

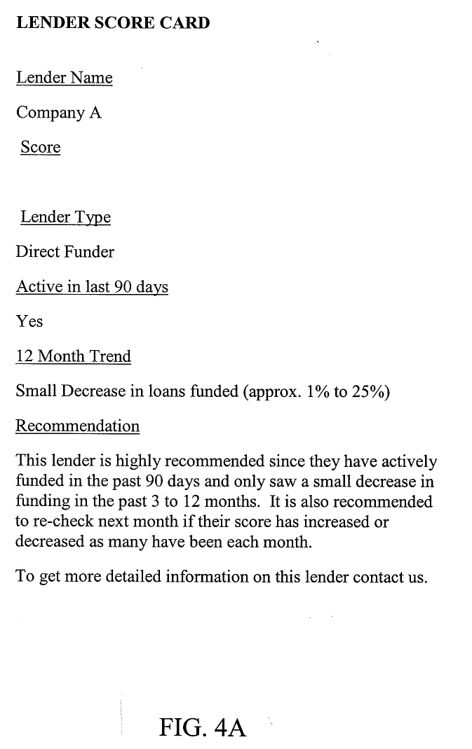

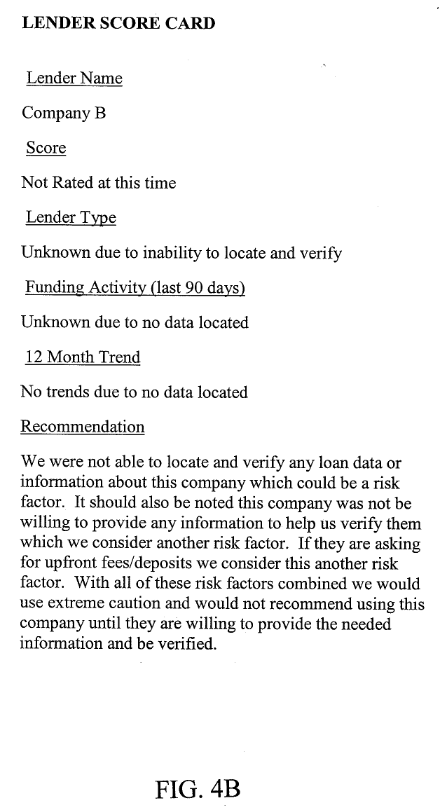

FIG. 4A shows an example of a GUI generated about a lender based on data gathered about a lender. This brief snap shot of a lender's risk is also referred to as a lender score card. Company A is a direct funder which received eight points. Based on the points, the activity in the last ninety days and the twelve month trend, a recommendation is produced. The recommendation and other information included in the score card may be a predefined template based on the score. Company A is a highly recommended lender because of its loan funded activity and points. Because the score and recommendation are based on a ninety day trend, the recommendation includes a reevaluation of Company A's score after 30 days.

At a decision block 28, the server 16 verifies if the lender is a funding source lender based on information in the database 18. Example funding source lenders include, but are not limited to, insurance companies, pension funds, agencies, capital and credit companies, REITs, investment banks, opportunity funds, hedge funds, endowment funds, foundations, advisors, trusts, high-net-worth individuals, domestic (regional to money-center) banks, foreign banks, and domestic and foreign syndicators. FIG. 4B is an example of a lender score card GUI similar to the lender score card GUI of FIG. 4A. In this example no data is available for Company B. The lender type is unknown due to the inability to locate and verify the lender. In addition, with no funding activity within the past ninety days or a twelve month trend available, no score is generated for Company B. The recommendation reflects the lack of information for Company B and Company B is considered a risk factor.

FIG. 5A is an example GUI of a detailed lender report, which is provided to the user containing information about the lender requested. The information in the report includes the same information as the lender score card, as shown in FIGS. 4A and 4B, but with additional detailed information (from the database 18) about the lender displayed in a more user friendly format. The lender type and rating, provided in a visual and numerical format, are presented at the top of the lender data column, as was also provided in the lender score card. The stars are comparable to the previously determined score/points. A scale for the rating system is also provided for ease of verifying the good, or bad, rating of a lender. As also provided in the lender score card and provided near the top of the detailed lender report are the funding activity of the lender for the last ninety days and for the last month. The detailed lender report also describes the funding activity as active or inactive. The percent increase or decrease in loan activity within the past three to twelve months is displayed in a numerical format with a explanation provided. The example in FIG. 5A describes a 16% decrease as a small decrease in loans funded.

Additional lender information provided by the detailed lender report includes the geographical area for the lender's funding activity and the range of loan amounts funded. The property type, loan type and lien position trends are also displayed in the report, as well as the loan volume within the past six to twelve months, to provide the user better information about the loans the lender typically funds. The remaining information in the detailed lender report goes beyond the information about the loans and provides details about the company itself. Information such as years in business, industry reputation, complaints against the lender, pending litigation, liens or judgments, bankruptcies, other affiliated entities, current license and status, sources of funds, and corporate office background provide the user a comprehensive overview of a lender's corporate health. This information is also retrieved from the database 18.

The lender information may also include accreditation information provided by third party verification companies and user feedback information received from the users or from another source.

The second page of the detailed lender report, as shown in FIG. 5B, is a summary of the information provided in the detailed lender report is shown in the form of multiple sliding scales. The scales provide a quick, easy to read summary of the recommendations for the lender. The scales range from “More Cautious” to “More Confident” to convey the overall risk assessment detailed in the recommendation of the detailed lender report. Other scale ranges may be used to provide a visual cue for a lender's performance. An overall recommendation based on the detailed lender report data and the sliding scales give the user a final summary of all the information detailed to assist the user in choosing a lender. Any notes from the lender interview are also included in the recommendation section to further assist the user.

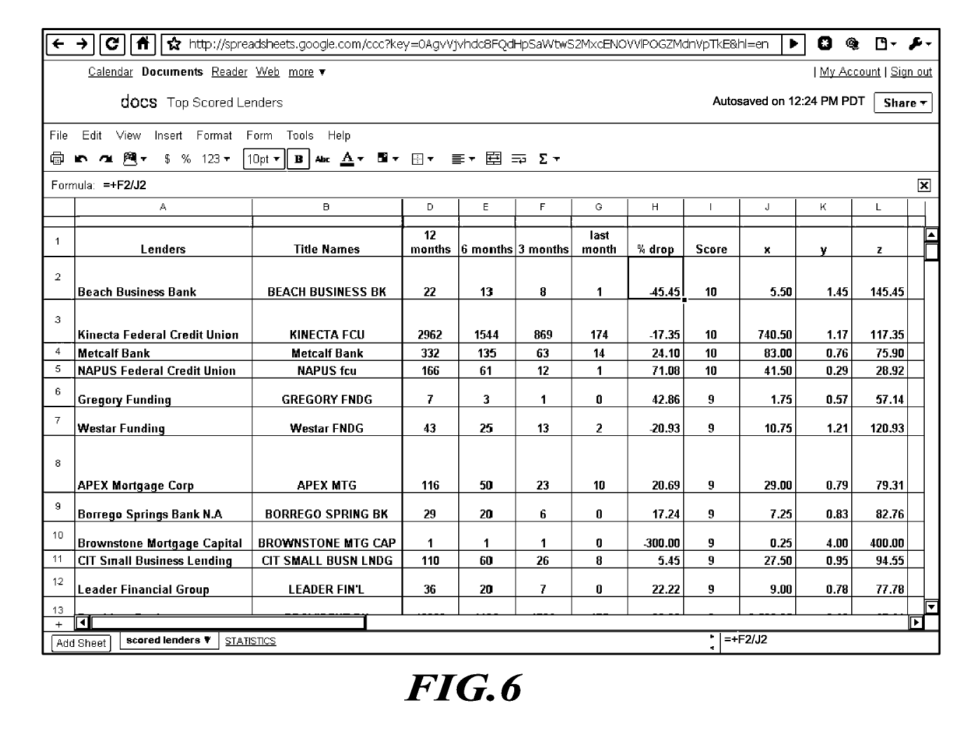

FIG. 6 shows an example screen shot of a GUI showing lender score information as well as additional data. This is in spreadsheet format allowing a user to sort by any of the columns. The database 18 stores the number of loans that each lender closed in the past one, three, six and twelve months in separate columns. The percent increase or decrease of closed loans is the determined value from the flowchart in FIG. 3. In addition, the columns labeled “x”, “y”, and “z” are also numbers generated from the flowchart in FIG. 3 and all four columns are used to calculate the score for each lender, which is also provided in the database.

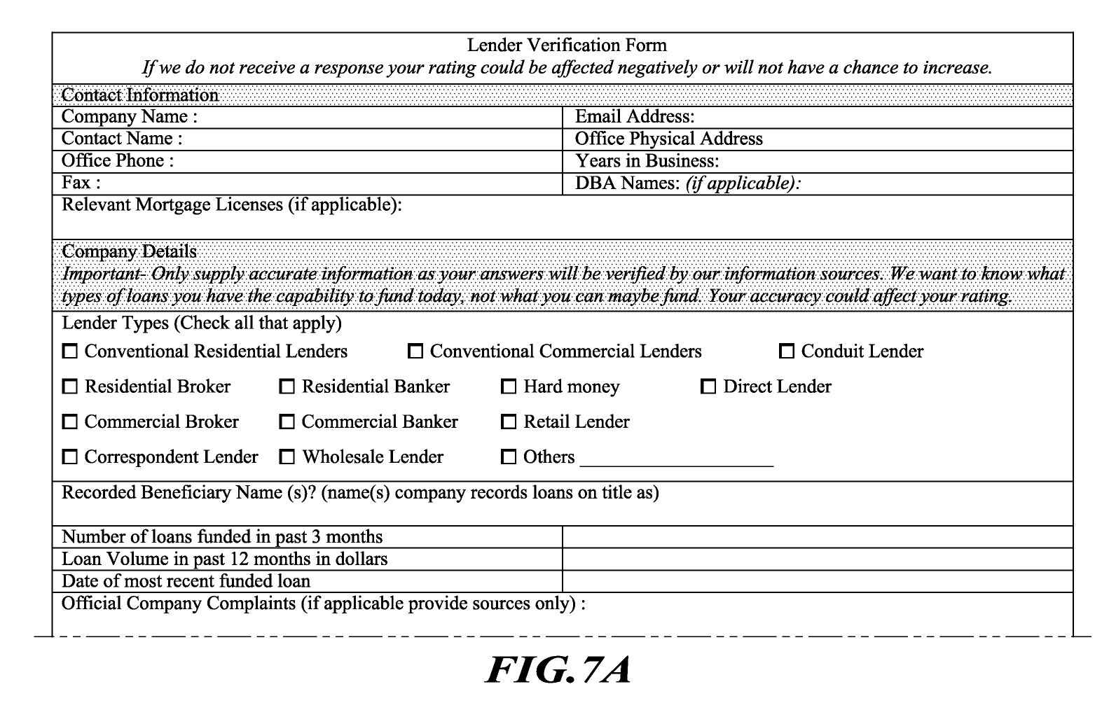

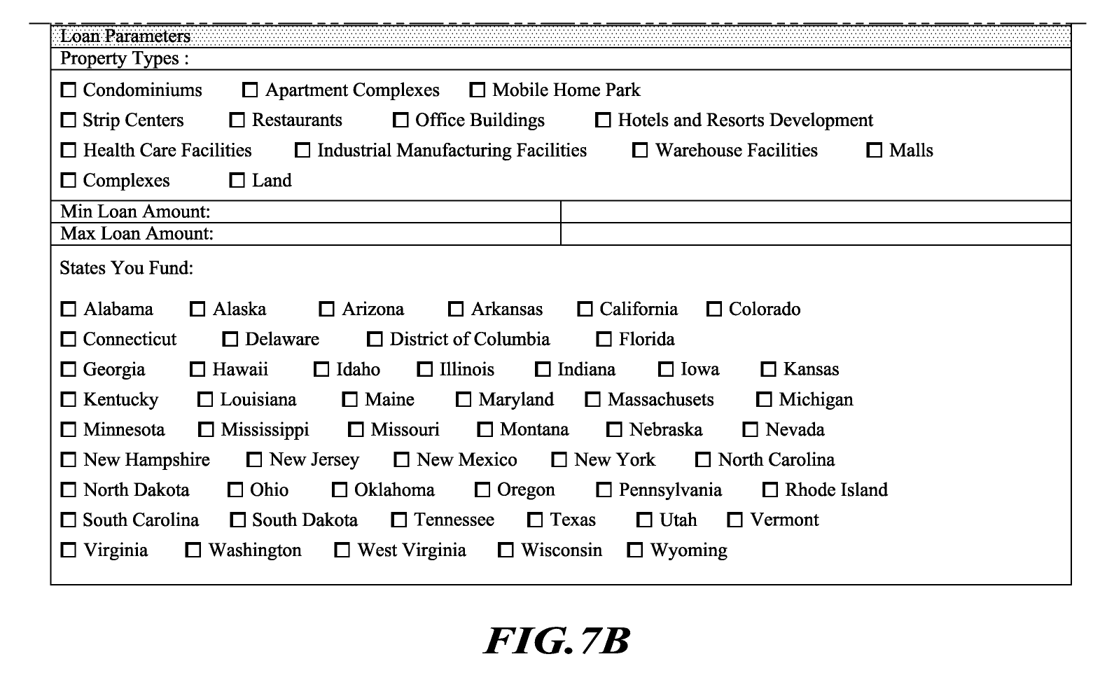

FIG. 7 is an example of a lender verification form. The lender verification form contains information provided by the lenders regarding details about the company. This information is cross referenced with the data for that lender in the database.

In another embodiment, a confidence and/or trust seal is applied to the outputted GUI for lenders that have a score above a predefined threshold.

In another embodiment, the present invention may be used for other types of mortgage financial companies such as banks, credit unions, loan modification companies, investment groups, mortgage brokers, etc.

In another embodiment, the company/lender being reviewed receives an additional point during the score generation process, if that company is willing to be transparent by registering and providing/updating their information/data beyond a threshold level. If there is a company like this and they have received a low score (i.e., below a threshold amount), then they will get a logo/icon outputted into the GUI that shows that they are a transparent company.

In another embodiment, the points can be converted into a rating scale of 0-5 and the points are on a 0-100 scale. For example, 80 points and above would convert to a 5 star rating.

While the preferred embodiment of the invention has been illustrated and described, as noted above, many changes can be made without departing from the spirit and scope of the invention. For example, this invention may be designed and provided to borrowers, realtors, investors, bankers, developers, realtors, brokers, consumers and anyone who a need to know this type of information. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for determining the lender score, the method comprising:
a) receiving a user request for a rating for a lender, wherein the request is received at a server from a user device over a network;
b) automatically retrieving recent loans funded based on the received request, wherein the recent loans the lender funded are stored in a database in communication with the server;
c) automatically determining a value for the lender based on the retrieved recent loans funded information;
d) automatically determining a points value based on a predefined points chart and the determined value;
e) automatically determining if the lender is a funding source lender based on information stored in the database;
f) automatically adding a point to the points value if the lender is a funding source lender;
g) automatically determining if the lender funded at least one loan in at least one previously defined period based on information stored in the database;
h) automatically adding a point to the points value if the lender funded at least one loan in at least one previously defined period;
i) automatically generating a rating base on the points value; and
j) automatically outputting the generated rating in a graphical user interface accessible by the user device over the network.

2. The method of claim 1, wherein automatically determining a value for the lender comprises:
automatically dividing number of loans the lender funded in last year by four, the result is X;
automatically dividing the number of loans the lender funded in the last three months by X, the result is Y;
automatically multiplying Y by 100, the result is Z; and
automatically subtracting Z from 100.

3. The method of claim 2, wherein automatically adding a point to the total lender points if the lender funded at least one loan in at least one previously defined period comprises:
automatically adding one point if at least one loan was funded in the last thirty days;
automatically adding one point if at least one loan was funded in the last ninety days;
automatically adding one point if at least one loan was funded in the last six months; and
automatically adding one point if at least one loan was funded in the last twelve months.

4. The method of claim 3, further comprising:
automatically repeating a)-j) for at least one other lender,
wherein the graphical user interface comprises a list of the generating ratings for a plurality of lenders.

5. The method of claim 1, wherein the graphical user interface comprises at least one of funding activity, volume trend, loan amount trends, property type trends, loan type trends; lien position trends, lone volume, years in business, liens, judgments, complaints, bankruptcies, current licenses, or funding source retrieved from the database.

6. A system for determining the lender score, the system comprising:
a means for receiving a user request for a score for a lender, wherein the request is received at a server from a user device over a network;
a means for automatically retrieving recent loans funded based on the received request, wherein the recent loans the lender funded are stored in a database in communication with the server;
a means for automatically determining a value for the lender based on the retrieved recent loans funded information;
a means for automatically determining a points value based on a predefined points chart and the determined value;
a means for automatically determining if the lender is a funding source lender based on information stored in the database;
a means for automatically adding a point to the points value if the lender is a funding source lender;
a means for automatically determining if the lender funded at least one loan in at least one previously defined period based on information stored in the database;
a means for automatically adding a point to the points value if the lender funded at least one loan in at least one previously defined period;
a means for automatically generating a score base on the points value; and
a means for automatically outputting a rating based on the generated score in a graphical user interface accessible by the user device over the network.

7. The system of claim 6, wherein the means for automatically determining a value for the lender comprises:
a means for automatically dividing number of loans the lender funded in last year by four, the result is X;
a means for automatically dividing the number of loans the lender funded in the last three months by X, the result is Y;
a means for automatically multiplying Y by 100, the result is Z; and
a means for automatically subtracting Z from 100.

8. The system of claim 7, wherein the means for automatically adding a point to the total lender points if the lender funded at least one loan in at least one previously defined period comprises:
a means for automatically adding one point if at least one loan was funded in the last thirty days;
a means for automatically adding one point if at least one loan was funded in the last ninety days;
a means for automatically adding one point if at least one loan was funded in the last six months; and
a means for automatically adding one point if at least one loan was funded in the last twelve months.

9. The system of claim 6, further comprising:
a means for automatically repeating for at least one other lender,
wherein the graphical user interface comprises a list of the generating ratings for a plurality of lenders.

10. The system of claim 6, wherein the graphical user interface comprises at least one of funding activity, volume trend, loan amount trends, property type trends, loan type trends; lien position trends, load volume, years in business, liens, judgments, complaints, bankruptcies, current licenses, or funding source retrieved from the database.
